(19) United States
(12) Patent Application Publication
(10) Pub. No.: US 2008/0181997 A1
(43) Pub. Date: Jul. 31, 2008

(54) Food product molding machine which does not use hydraulics

(75) Inventor: Gary Cowart, Conyers, GA (US)

Correspondence Address: WEISS & WEISS;Suite 251, 300 Old Country Road, Mineola, NY, 11501, US

(73) Assignee: MP EQUIPMENT CO., INC.

(21) Appl. No.: 11/698,001

(22) Filed: Jan. 25, 2007

(51) Int. Cl. A47J 43/20

(52) U.S. Cl. 426/389; 425/145

(57) ABSTRACT

A food product-molding machine that does not use hydraulics for the manufacture of food patties.

### FIELD OF THE INVENTION

The present invention relates to a food product-molding machine that does not use hydraulics in the manufacture of food patties.

### BACKGROUND OF THE INVENTION

Prior art patty-molding machines have all used hydraulics, which is cumbersome and expensive to maintain over time.

U.S. patent publication number 2005/00743338 relates to a hydraulic system for a reciprocating mold plate, patty-forming apparatus wherein food product is delivered under pressure from a pump cylinder to mold plate cavities. The plunger is driven during a first phase by force from a hydraulic cylinder from a retracted position distant from the pump cylinder to a ready position initially compressing food product loaded into the pump cylinder. The plunger is driven during a second phase by the hydraulic cylinder to load food product under pressure into the mold plate cavities. The hydraulic cylinder is supplied with hydraulic fluid during the first phase by a low-pressure hydraulic fluid pump and during the second phase by a high-pressure hydraulic fluid pump.

U.S. patent publication number 2005/0074513 relates to a reciprocating mold plate food patty forming machine that includes a mold plate that reciprocates between a cavity fill position and a patty discharge position. The machine base 21 supports the operating mechanism for machine 20 and can contain hydraulic actuating systems, electrical actuating systems and most of the machine controls. The first and second food pumps include hydraulic cylinders.

U.S. patent publication number 2005/0095309 relates to a drive system for a knockout apparatus for a patty forming machine. The machine includes an electric motor, a rotary two linear motion converting apparatus connected to the electric motor, and at least one knockout member connected between the rotary two linear motion converting apparatus and the knockout plungers, to reciprocate the knockout plunger. The first and second food pumps include hydraulic cylinders.

U.S. patent publication number 2005/0103207 relates to a drive system for a reciprocating mold plate patty forming machine. The first and second food pumps include a hydraulic cylinder.

U.S. Pat. Nos. 5,655,436, 5,730,650 and 5,980,228 relate to a food patty molding machine which utilizes a linearly reciprocal mold plate having a direct rotary actuator drive which provides virtually direct linear transfer of the drive force to the ends of the linear drive shafts which support the mold plate. Servo valve control of the hydraulic power unit, which drives the rotary actuator and the feed ram cylinders, also responds to suitably processed encoder signals. The power unit includes the usual motor driven hydraulic pump, associated control valves, fluid supply and return lines, and reservoir.

U.S. Pat. No. 6,156,358 relates to a food product-molding machine, which utilizes a hydraulically driven feed ram to move food product into the cavities of a reciprocating mold plate.

U.S. patent publication number 2002/0182297 relates to a machine for forming food patties in which multiple rows of food patties are extruded into a mold plate through separate fill slots. The machine employs plungers operated by hydraulic cylinders and piston assemblies to extrude food material from slots in the fill plate through application of hydraulic pressure.

U.S. patent publication number 2005/0072312 relates to a food product hopper assembly from a food patty molding machine. The first and second food pumps include a hydraulic cylinder.

U.S. patent publication number 2005/0072313 relates to a frame structure for a reciprocating mold plate type food product forming apparatus. A plurality of tie rods span between a backing plate that mounts a hydraulic cylinder that drives the plunger and the pump cylinder. A typical forming apparatus comprises at least one hydraulically driven pump that includes a pump piston or plunger driven into a pump cylinder by a hydraulic cylinder to pressurize food product.

U.S. patent publication number 2005/0072314 relates to a breather system for a reciprocating mold plate, patty forming machine. The first and second food pumps include hydraulic cylinders.

### SUMMARY OF THE INVENTION

The present invention relates to a food product molding machine comprising: a servo tube valve linear actuator; mold plate drive servo motor; servo mold plate drive gearbox; servo knock out drive; servo plunger linear actuators; and a programmable logical control for operating the servo drives. It is an object of the present invention for the machine to have no hydraulic systems for forming food patties. It is an object of the present invention for the machine to have a mold plate which has a variable stroke length.

The present invention relates to a process for providing moldable food comprising: placing food in a hopper. The food is moved from hopper to augers, and then from the augers to a pump box. Once in the pump box the food is pushed with a plunger actuator operated by a servo motor into a tube valve operated by a servo motor. The tube valve is opened and closed to let food go in and out. The food is moved from the tube valve into a fill area. A mold plate is moved in a reciprocating motion operated by a servo motor to a back and fill position. The food is then knocked out by a knock out member operated by a servo motor. It is an object of the present invention for the process to require no hydraulic systems in the manufacture of food patties. It is an object of the present invention for the servo motors to be controlled by a programmable logical control. It is an object of the present invention for the mold plate to be operable with a variable stroke length.

It is an object of the present invention for the food product molding machine to comprise a plurality of feed chambers configured to pressurize a food product and a molding plate having a cavity. It is an object of the present invention for the machine to further include a manifold configured to communicate the food product under pressure from the feed chamber to the cavity of the molding plate. It is an object of the present invention for the manifold to include an interior cavity split by an interior wall having any number of chambers or passages through the manifold. The molding machine does not contain any hydraulics for the manufacture food patties, and only contains servo motors.

It is an object of the present invention to provide a method of communicating a food product under pressure through a manifold from a plurality of feed chambers to a mold plate, wherein the method of communication comprises the use of servo motors, without any use of hydraulics in the manufacture of food patties. The method comprises the acts of dividing a supply of food product into a multiple portions; providing a first portion of food product under pressure in a first passage in the manifold associated with one of a first pair of alternating feed chambers simultaneous with providing a second portion of food product under pressure in a second passage in the manifold associated with one of a second pair of alternating feed chambers; and providing the first portion of food product through the first passage of the manifold to the molding plate simultaneous with providing the second portion of food product through the second passage of the manifold to the molding plate.

It is an object of the present invention utilizing a pair of plungers extending and retracting independently. The product conveyor brings product to the feedscrews. The left and center feedscrews will rotate, augering product in front of the #1 plunger. The tube valve will shift opening the tube manifold to the #1 plunger and closing the manifold to the #2 plunger. The #1 plunger will advance pushing product into the pump box. The #1 plunger energizes and de-energizes product thru tube valve assembly to the Mold Plate depending on the position of the mold plate.

When #1 plunger is fully advanced, the right and center feedscrews rotate, augering product in front of plunger #2. The Tube Valve will shift, opening the Tube Valve manifold to the #2 plunger and closing the manifold to the #1 plunger. #2 plunger advances pushing product into the pump box, #1 plunger retracts, #2 plunger repeats fill cycle.

It is an object of the present invention to provide a food product molding machine that includes a series of plunger assemblies. The machine further includes a series of feed chambers, each of which is configured to receive one of the plunger assemblies. The plunger assemblies operate simultaneously and in alteration with other plunger assemblies to force a food product through each of a passage in a manifold to fill a mold plate. The plunger assemblies operate via servo motors, using no hydraulics in the production of the food patties.

It is an object of the present invention to provide a method of pumping a food product to fill a cavity of mold plate using a series of plunger assemblies, the method comprising the acts of activating a first set of plunger assemblies to operate simultaneously to force a food product to fill a cavity of a mold plate; retracting the first set of plunger assemblies to receive a new supply of food product; and activating a second set of plunger assemblies to operate simultaneously to provide a food product to fill the cavity of the mold plate. The plunger assemblies operate via servo motors, using no hydraulics in the production of the food patties.

It is an object of the present invention to provide a valve configured to selectively communicate a food product fed under pressure from a feed chamber to a manifold connected to a fill slot for filling a cavity of a mold plate.

The present invention includes a food hopper, a conveyor assembly configured to deliver a supply of food product to an auger assembly. The auger assembly regulates the supply of food product to a pump system.

The pump system includes a series of plunger assemblies. The plunger assemblies pressurize or force the food product through a feed chamber/manifold assembly and into a series of cavities of a mold plate. The pressure applied by each plunger assembly regulates the compression of the food product in the cavities of the mold plate. A knockout assembly separates the formed food product or patty from the mold plate.

The feed chamber/manifold assembly is disposed to provide a pressurized flow of food product to a fill slot disposed in a fill plate. A mold drive system reciprocates the mold plate back and forth in alignment with the fill slot of the fill plate to receive the pressurized food product into the plurality of cavities in the mold plate. After filling the cavities, the mold drive system slides the mold plate outward from alignment with the fill slot, where the knockout assembly discharges the molded food product from the cavities of the mold plate, typically onto an underlying conveyor.

The plunger assemblies are aligned horizontally and include servo motors configured to reciprocate respective plungers in a back and forth manner. The type of pump system (e.g., screw pumps, plungers, etc.) can vary.

The feed chamber/manifold assembly includes a feed chamber assembly and a manifold assembly. The feed chamber assembly includes horizontal feed chambers aligned with a respective plunger assembly. Each plunger assembly reciprocates back and forth inside its respective feed chamber. The reciprocation of the plunger assemblies forces a food product under pressure into the manifold assembly. The fill plate defines the top of the downstream end of the feed chamber assembly and the top of the manifold assembly. A manifold control valve is disposed between the feed chamber assembly and the manifold assembly to control the flow of food product into and through the manifold assembly.

It is an object of the present invention for each plunger in an assembly to be paired with another plunger and to extend and retract simultaneously with the other plunger assembly. For example, two inner plunger assemblies extend and retract simultaneously, and two outer pump assemblies extend and retract simultaneously. Of course, the pairing of the plunger assemblies (e.g., first and third, second and fourth, etc.) can vary.

The manifold assembly defines the downstream end of the feed chamber assembly. The manifold assembly includes a series of inlet ports configured to receive a food product under pressure from the feed chamber assembly. Each inlet port is configured to align each respective feed chamber of the feed chamber assembly. The manifold assembly also includes an interior wall configured to create a first passage and a second passage through the manifold assembly.

It is an object of the present invention for a manifold valve to include a first plate disposed adjacent to a second plate along their faces. Each plate includes an extension respectively, that cooperate to form an opening or passage configured to receive a third plate. The first plate includes a plurality of elongated openings aligned with a plurality of similar openings in the second plate. The third plate also includes a plurality of elongated openings operable to selectively align with openings of the first and second plates. The third plate is configured to slide in the passage formed between the first and second plates, regulating the flow of food product through the openings in the first plate and the second plate.

In operation, food product is fed under pressure by alternating plunger assemblies through a series of feed chamber assemblies. One pair of pump assemblies operates simultaneous with a second pair of pump assemblies, to provide a first portion and a second portion of food product through feed chambers respectively. An actuator selectively slides a third plate of manifold valve in a lateral direction toward a first position to selectively communicate the first position of food product from feed chamber simultaneous with the second portion of food product from feed chamber through respective passages in the manifold assembly. In this position, third plate blocks the first plate openings in alignment with the feed chambers. The pump assemblies are then retracted, and the second of the first pair of pump assemblies operates simultaneous with a second of the second pair of pump assemblies to provide a third portion and fourth portion of food product through the feed chambers respectively. The actuator selectively slides the manifold valve in a lateral direction toward a second position to selectively communicate the third portion of food product from the feed chambers simultaneous with the fourth portion of food product from feed chamber through the first and second passages of the manifold assembly. In this position, third plate blocks the first plate openings in alignment with feed chambers. Thereafter, the cyclic operation of the pump assemblies and the actuator and manifold valve work continuously to provide a constant pressure and uniform flow of pressurized food product through the manifold assembly to the reciprocating mold plate.

It is an object of the present invention to provide a machine having no hydraulics for the production of food patties, wherein food material is stored in a hopper. The hopper opens into a pump box that has a top plate. Inside the pump box is a plunger. It is an object of the present invention for the machine to have a drive linkage and draw bar assembly. It is an object of the present invention to have a mold plate fastened to the draw bar assembly. The mold plate has a number of cavities. It is an object of the present invention to have a mold plate located between a fill plate and a breather plate. The fill plate has one or more fill slots. A knockout mechanism ejects the food product from the cavities in the form of the individual items.

It is an object of the present invention to provide a method for making food patties comprising loading a quantity of food into a hopper of a molding machine. The food is then forced from the hopper through a pump box and into a manifold. The food then flows from the manifold through fill slots into multiple cavities in a mold plate. The mold plate with the fill cavities advances in a longitudinal direction to a knockout station, where the food is pushed out of the cavities. The mold plate then returns to a fill station for refilling the cavities.

It is an object of the present invention for the only hydraulics to be used on the machine to be used to operate the mold cover when it is cleaned.

Many variations of the invention can be made without departing from the spirit and scope of the invention.

### BRIEF DESCRIPTION OF THE DRAWINGS

FIG. 1 shows a side view of a prior art device.

FIG. 2 shows a side view of the device of the present invention.

FIG. 3a shows a top view of the servo unit.

FIG. 3b shows a side view of the servo unit.

FIG. 3c shows a bottom view of the servo unit.

FIG. 3d shows a rear view of the servo unit.

FIG. 4a shows a top view of the device of the present invention.

FIG. 4b shows a side view of the device of the present invention.

FIG. 4c shows a bottom view of the device of the present invention.

FIG. 4d shows a rear view of the device of the present invention.

FIG. 4e shows a front view of the device of the present invention.

FIG. 5a shows a top view of a prior art hydraulic power unit.

FIG. 5b shows a side view of a prior art hydraulic power unit.

FIG. 5c shows a bottom view of a prior art hydraulic power unit.

FIG. 5d shows a rear view of a prior art hydraulic power unit.

FIG. 5e shows a front view of a prior art hydraulic power unit.

FIG. 6a shows a top view of a prior art frame for a hydraulic power unit.

FIG. 6b shows a side view of a prior art frame for a hydraulic power unit.

FIG. 6c shows a bottom view of a prior art frame for a hydraulic power unit.

FIG. 6d shows a rear view of a prior art frame for a hydraulic power unit.

FIG. 6e shows a front view of a prior art frame for a hydraulic power unit.

### DETAILED DESCRIPTION OF THE INVENTION

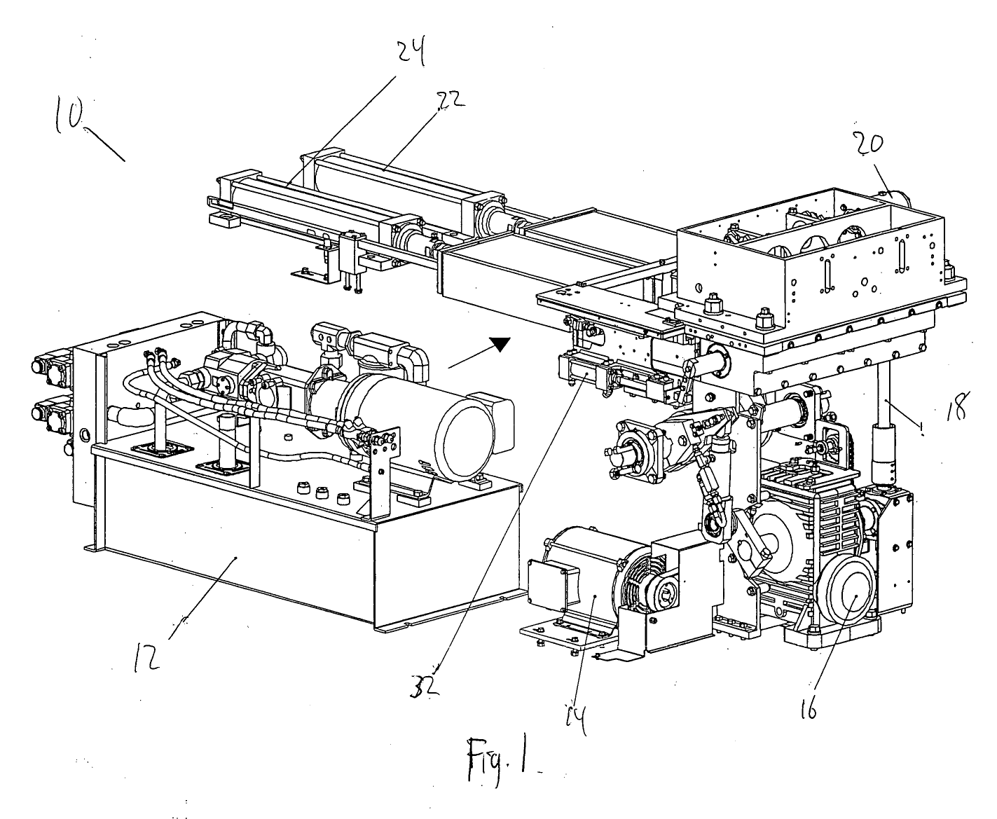

FIG. 1 shows a side view of a prior art food product molding machine which contains the hydraulic system. The prior art food product molding machine 10 comprises a hydraulic power unit 12, which takes a tremendous amount of space in the design of the machine. The machine further comprises an hydraulic tube valve actuator 32, and gearbox drive motor 14, a mold plate and knock out drive gear box 16, knock out drive shaft 18, and an upper knock out gearbox 20. The device further comprises hydraulic plunger actuators 22 and 24.

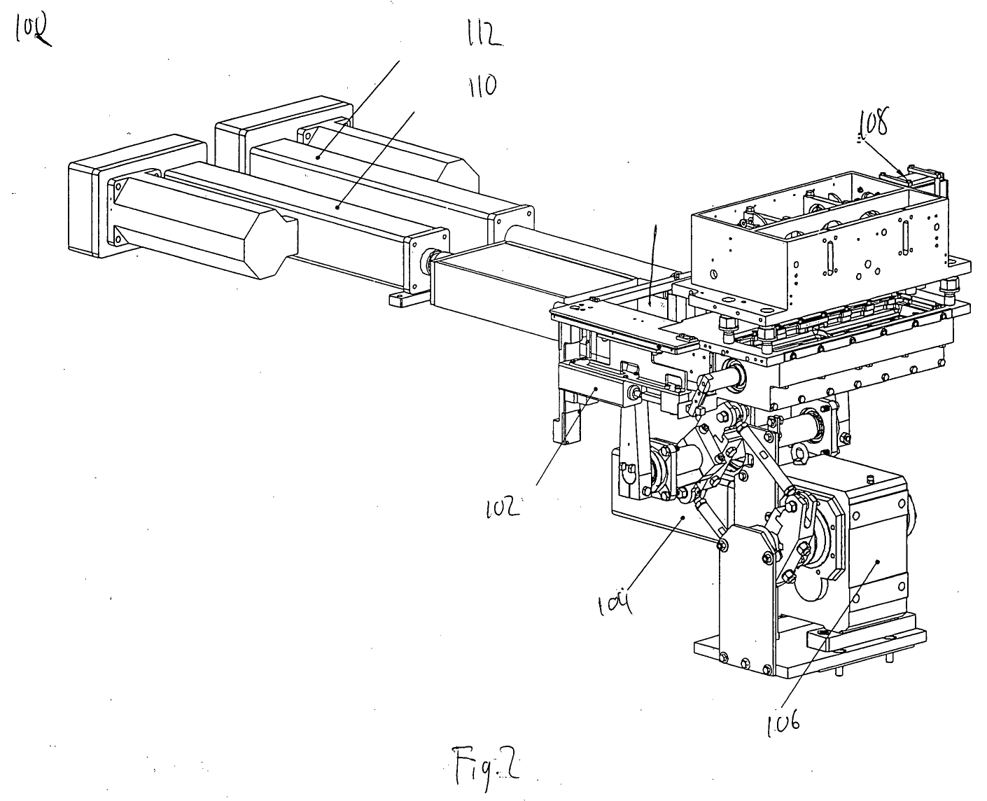

FIG. 2 shows a side view of the food product molding machine 100 of the present invention. The device 100 comprises a servo tube valve linear actuator 102, mold plate drive servo motor 104, servo mold plate drive gearbox 106, and servo knock out drive 108. The device further comprises servo plunger linear actuators 110 and 112.

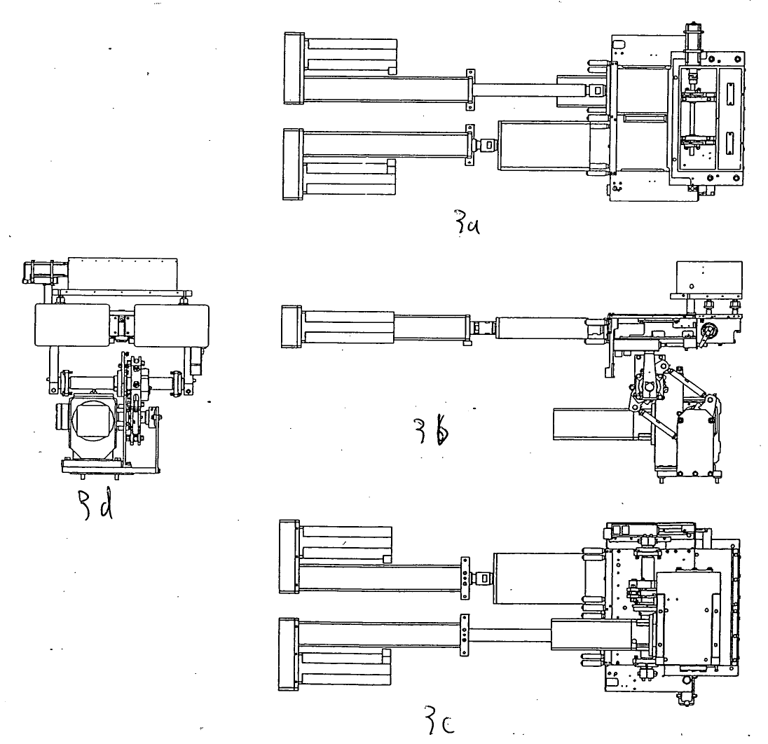

FIG. 3a shows a top view of the servo unit. FIG. 3b shows a side view of the servo unit. FIG. 3c shows a bottom view of the servo unit. FIG. 3d shows a rear view of the servo unit.

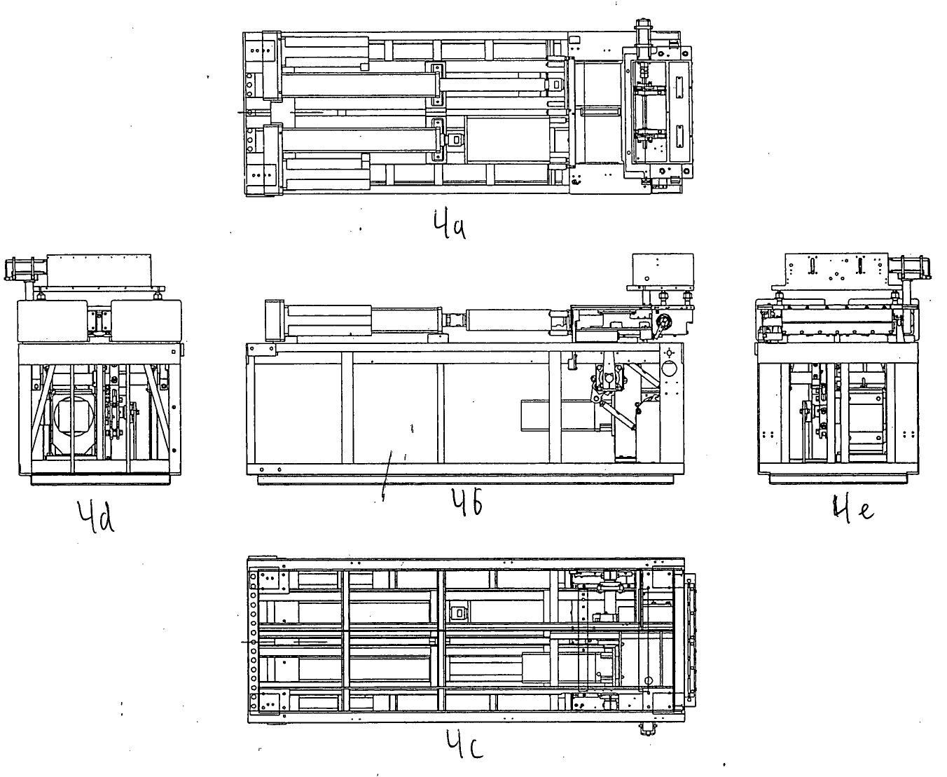

FIG. 4a shows a top view of the device of the present invention. FIG. 4b shows a side view of the device of the present invention. FIG. 4c shows a bottom view of the device of the present invention. FIG. 4d shows a rear view of the device of the present invention. FIG. 4e shows a front view of the device of the present invention.

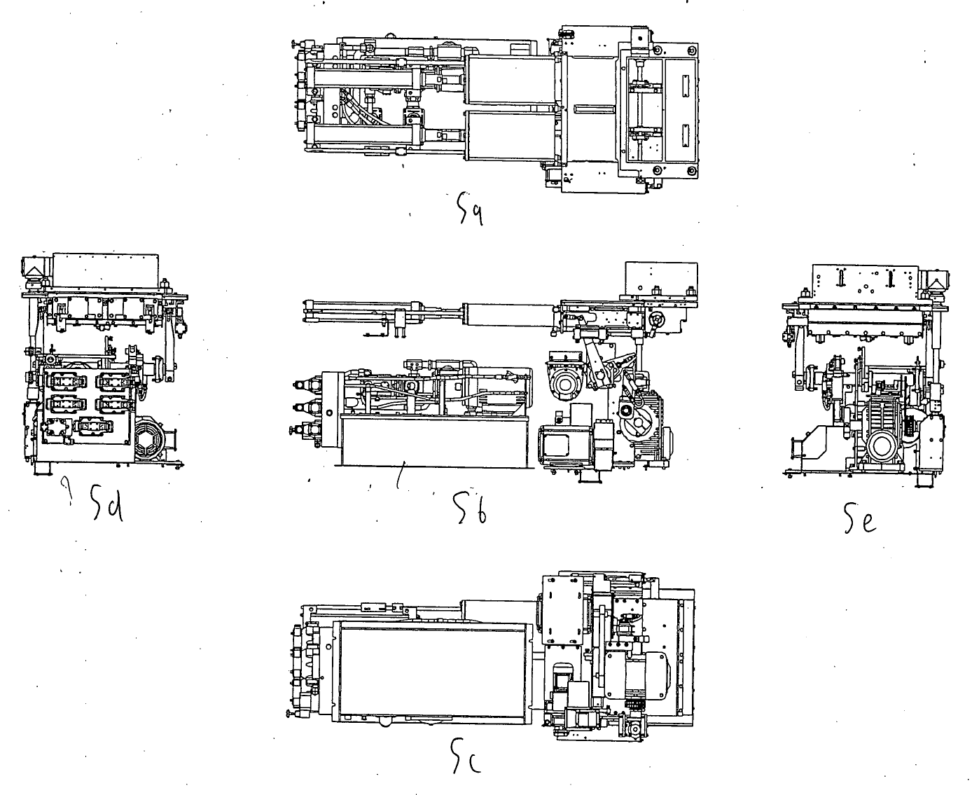

FIG. 5a shows a top view of a prior art hydraulic power unit. FIG. 5b shows a side view of a prior art hydraulic power unit. FIG. 5c shows a bottom view of a prior art hydraulic power unit. FIG. 5d shows a rear view of a prior art hydraulic power unit. FIG. 5e shows a front view of a prior art hydraulic power unit.

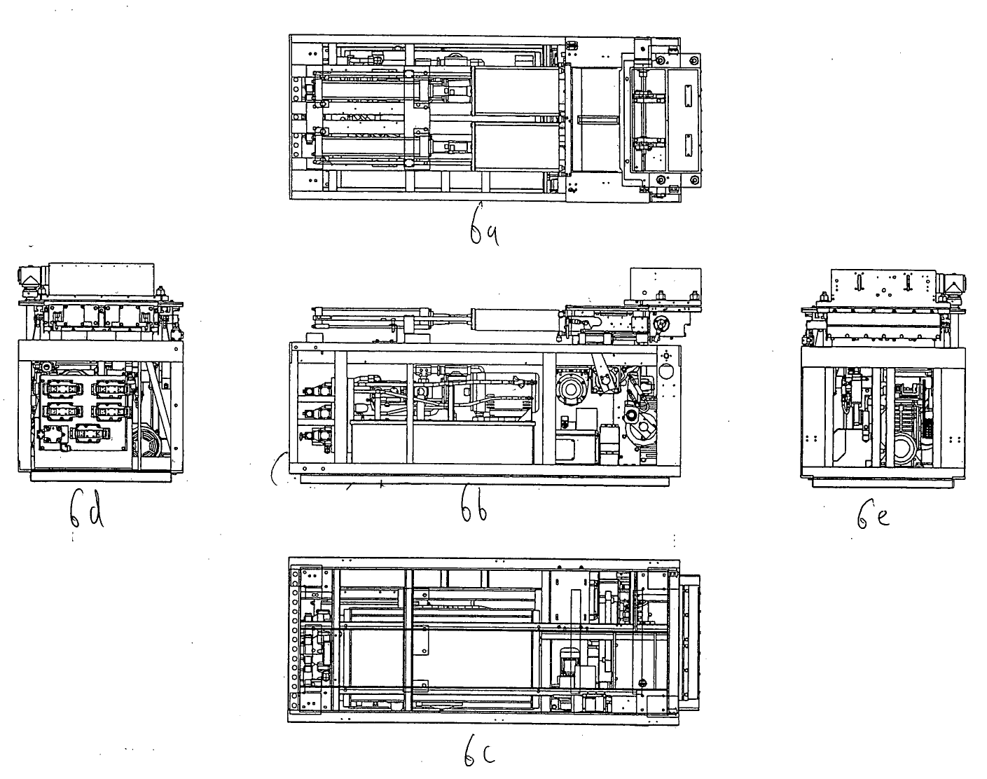

FIG. 6a shows a top view of a prior art frame for a hydraulic power unit. FIG. 6b shows a side view of a prior art frame for a hydraulic power unit. FIG. 6c shows a bottom view of a prior art frame for a hydraulic power unit. FIG. 6d shows a rear view of a prior art frame for a hydraulic power unit. FIG. 6e shows a front view of a prior art frame for a hydraulic power unit.

1. A food product molding machine comprising:
a servo tube valve linear actuator;
mold plate drive servo motor;
servo mold plate drive gearbox;
servo knock out drive;
servo plunger linear actuators;
a programmable logical control for operating the servo drives.

2. The machine of claim 1 wherein said machine has no hydraulic systems associated with production of said food product.

3. The machine of claim 1 wherein said mold plate has a variable stroke length.

4. A process for providing moldable food comprising:
placing food in a hopper;
moving said food from said hopper to augers;
moving said food from said augers to a pump box;
pushing said food by a plunger actuator operated by a servo motor into a tube valve operated by a servo motor;
opening and closing said tube valve to let said food go in and out;
moving said food from said tube valve into a fill area;
reciprocating a mold plate operated by a servo motor to a back and fill position;
knocking out said food by a knock out member operated by a servo motor.

5. The method of claim 4 wherein said process requires no hydraulic systems associated with production of said food product.

6. The method of claim 4 wherein said servo motors are controlled by a programmable logical control.

7. The method of claim 4 wherein said mold plate operates with a variable stroke length.
